(19) United States
(12) Patent Application Publication
(10) Pub. No.: US 2015/0027126 A1
(43) Pub. Date: Jan. 29, 2015

(54) SYSTEM FOR PROVIDING FUEL TO A COMBUSTOR

(71) Applicant: General Electric Company, Schenectady, NY (US)

(72) Inventor: Jonathan Dwight Berry, Simpsonville, SC (US)

(21) Appl. No.: 13/949,640

(22) Filed: Jul. 24, 2013

(51) Int. Cl. F02C 7/22; F23R 3/28

(52) U.S. Cl. CPC F02C 7/222; F23R 3/28
USPC 60/739

(57) ABSTRACT

A fuel supply system for a gas turbine combustor includes an annular duct that at least partially defines a hot gas path within the combustor. An orifice is at least partially defined by the annular duct and defines a flow path through the annular duct into the hot gas path. A plurality of fuel injectors are arranged circumferentially around the annular duct to provide for fluid communication through the annular duct into the hot gas path. A fuel distribution manifold is disposed adjacent to an outer side of the annular duct. The fuel distribution manifold includes a main body that at least partially defines an inlet for receiving fuel, an outlet that is in fluid communication with the fuel injectors, and a fuel purge passage that provides for fluid communication between the inlet and the orifice.

### FEDERAL RESEARCH STATEMENT

This invention was made with Government support under Contract No. DE-FC26-05NT42643, awarded by the Department of Energy. The Government has certain rights in the invention.

### FIELD OF THE INVENTION

The present invention generally involves a combustor of a gas turbine. More specifically, the invention relates to a system for providing fuel to a fuel injector disposed downstream from a primary combustion zone defined within the combustor.

### BACKGROUND OF THE INVENTION

Combustors are commonly used in industrial and power generation operations to ignite fuel to produce combustion gases having a high temperature and pressure. For example, turbomachines such as gas turbines typically include one or more combustors to generate power or thrust. A typical gas turbine includes an inlet section, a compressor section, a combustion section, a turbine section, and an exhaust section. The inlet section cleans and conditions a working fluid (e.g., air) and supplies the working fluid to the compressor section. The compressor section progressively increases the pressure of the working fluid and supplies a compressed working fluid to the combustion section. A fuel is mixed with the compressed working fluid within the combustion section and the mixture is burned in a combustion chamber defined within the combustion section to generate combustion gases having a high temperature and pressure. The combustion gases flow to the turbine section where they expand to produce work. For example, expansion of the combustion gases in the turbine section may rotate a shaft connected to a generator to produce electricity.

A typical combustor includes an end cover coupled to a compressor discharge casing, an annular cap assembly that extends radially and axially within the compressor discharge casing, an annular combustion liner that extends downstream from the cap assembly, and a transition piece having an annular transition duct that extends between the combustion liner and a first stage of stationary nozzles. The stationary nozzles are positioned generally adjacent to an inlet to the turbine section.

In a particular combustor design, one or more fuel injectors, also known as late lean fuel injectors, are circumferentially arranged around the combustion liner downstream from the fuel nozzles. The fuel injectors provide for fluid communication through the liner and into the hot gas path. Current systems for providing fuel to the fuel injectors comprise various fluid conduits and fluid couplings that extend within the compressor discharge casing to route fuel from a fuel source to the late lean fuel injectors. Access to the various fluid couplings, fluid conduits and/or the late lean fuel injectors may be restricted during installation and/or removal of the combustor due to limited space provided within the compressor discharge casing. As a result, fuel connections made between the fuel source and the late lean fuel injectors are challenging and labor intensive. Therefore, an improved system for providing fuel to the combustor, particularly to the late lean fuel injectors would be useful.

### BRIEF DESCRIPTION OF THE INVENTION

Aspects and advantages of the invention are set forth below in the following description, or may be obvious from the description, or may be learned through practice of the invention.

One embodiment of the present invention is a fuel supply system for a gas turbine combustor. The fuel supply system includes an annular duct that at least partially defines a hot gas path within the combustor. The annular duct includes an inner side and an outer side. An orifice is at least partially defined by the annular duct. The orifice defines a flow path through the annular duct into the hot gas path. A plurality of fuel injectors are arranged circumferentially around the annular duct. The fuel injectors provide for fluid communication through the annular duct into the hot gas path. The system further includes a fuel distribution manifold that is disposed adjacent to the outer side of the annular duct. The fuel distribution manifold comprises a main body that at least partially defines an inlet for receiving fuel, an outlet that is in fluid communication with the fuel injectors and a fuel purge passage that provides for fluid communication between the inlet and the orifice.

Another embodiment of the present invention is a combustor. The combustor includes an outer casing and an end cover that at least partially encase the combustor. A fuel nozzle extends axially downstream from the end cover and an annular duct extends downstream from the fuel nozzle. The annular duct at least partially defines a hot gas path within the combustor. An orifice defines a flow path through the annular duct into the hot gas path downstream from the fuel nozzle. A plurality of fuel injectors are arranged circumferentially around the annular duct. The fuel injectors provide for fluid communication through the annular duct into the hot gas path downstream from the fuel nozzle. A fuel distribution manifold is coupled to the annular duct upstream from the fuel injectors. The fuel distribution manifold comprises a main body that at least partially defines an inlet for receiving fuel, an outlet that is in fluid communication with the fuel injectors and a fuel purge passage that is in fluid communication with the orifice. The fuel purge passage defines a flow path within the main body for routing leaked fuel from the inlet into the hot gas path.

Another embodiment of the present invention is a gas turbine. The gas turbine includes a compressor, a combustor disposed downstream from the compressor and a turbine that is disposed downstream from the combustor. An outer casing and an end cover at least partially encase the combustor. A fuel nozzle extends axially downstream from the end cover and an annular duct extends downstream from the fuel nozzle. The annular duct at least partially defines a hot gas path within the combustor. An orifice defines a flow path through the annular duct into the hot gas path downstream from the fuel nozzle. A plurality of fuel injectors are arranged circumferentially around the annular duct. The fuel injectors provide for fluid communication through the annular duct into the hot gas path downstream from the fuel nozzle. A fuel distribution manifold is coupled to the annular duct upstream from the fuel injectors. The fuel distribution manifold comprises a main body that at least partially defines an inlet for receiving fuel, an outlet that is in fluid communication with the fuel injectors and a fuel purge passage that is in fluid communication with the orifice. The fuel purge passage defines a flow path within the main body for routing leaked fuel from the inlet into the hot gas path via the orifice.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a functional block diagram of an exemplary gas turbine within the scope of the present invention;

FIG. 2 is a cross sectional side view of a portion of an exemplary gas turbine, including an exemplary combustor that may encompass various embodiments of the present invention;

FIG. 3 is a perspective view of a system for providing fuel to the combustor as shown in FIG. 2, according to one embodiment of the present invention;

FIG. 4 is a cross section side view of a portion of the system as shown in FIG. 3, according to one embodiment of the present invention;

FIG. 5 is a cross section side view of the system as shown in FIG. 3, according to one embodiment of the present invention;

FIG. 6 is a cross sectional side view of the combustor as shown in FIG. 2, according to one embodiment of the present invention; and

FIG. 7 is a perspective view of the system for providing fuel to the combustor as shown in FIG. 6, according to one embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, and the term “axially” refers to the relative direction that is substantially parallel to an axial centerline of a particular component.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents. Although exemplary embodiments of the present invention will be described generally in the context of a combustor incorporated into a gas turbine for purposes of illustration, one of ordinary skill in the art will readily appreciate that embodiments of the present invention may be applied to any combustor incorporated into any turbomachine and are not limited to a gas turbine combustor unless specifically recited in the claims.

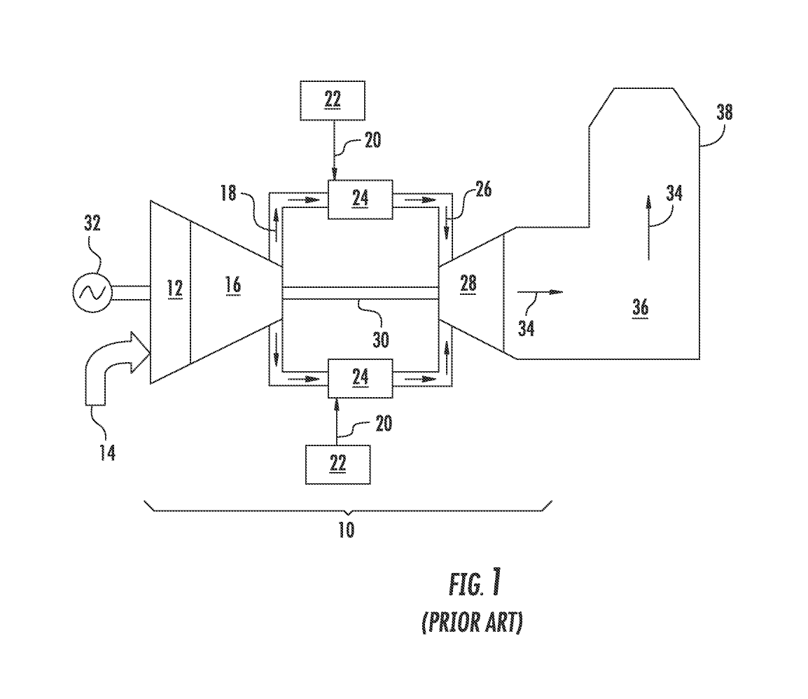

Referring now to the drawings, wherein identical numerals indicate the same elements throughout the figures, FIG. 1 provides a functional block diagram of an exemplary gas turbine 10 that may incorporate various embodiments of the present invention. As shown, the gas turbine 10 generally includes an inlet section 12 that may include a series of filters, cooling coils, moisture separators, and/or other devices to purify and otherwise condition a working fluid (e.g., air) 14 entering the gas turbine 10. The working fluid 14 flows to a compressor section where a compressor 16 progressively imparts kinetic energy to the working fluid 14 to produce a compressed working fluid 18.

The compressed working fluid 18 is mixed with a fuel 20 from a fuel source 22 such as a fuel skid to form a combustible mixture within one or more combustors 24. The combustible mixture is burned to produce combustion gases 26 having a high temperature, pressure and velocity. The combustion gases 26 flow through a turbine 28 of a turbine section to produce work. For example, the turbine 28 may be connected to a shaft 30 so that rotation of the turbine 28 drives the compressor 16 to produce the compressed working fluid 18. Alternately or in addition, the shaft 30 may connect the turbine 28 to a generator 32 for producing electricity. Exhaust gases 34 from the turbine 28 flow through an exhaust section 36 that connects the turbine 28 to an exhaust stack 38 downstream from the turbine 28. The exhaust section 36 may include, for example, a heat recovery steam generator (not shown) for cleaning and extracting additional heat from the exhaust gases 34 prior to release to the environment.

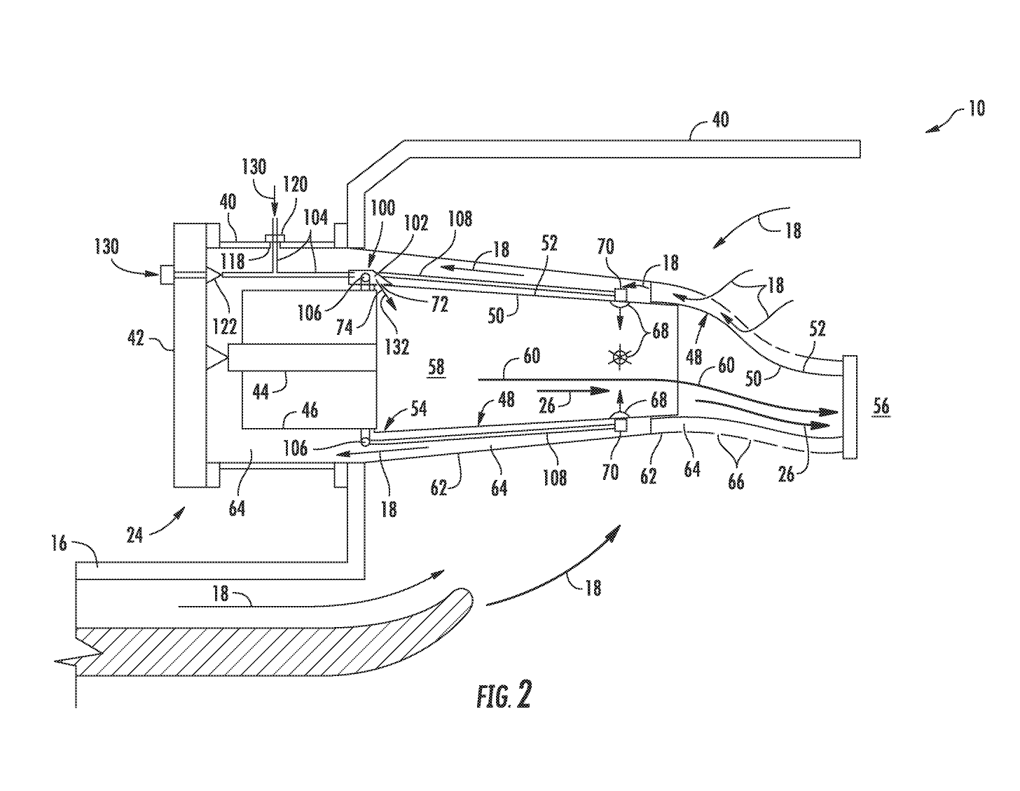

FIG. 2 provides a simplified side cross-section view of an exemplary combustor 24 according to various embodiments of the present invention. As shown in FIG. 2, an outer casing 40 and an end cover 42 that is disposed at one end of the combustor 24 and coupled to the outer casing 40 may at least partially encase the combustor 24 so as to contain the compressed working fluid 18 flowing to the combustor 24 from the compressor 16. A fuel nozzle 44 extends axially downstream from the end cover 42. The fuel nozzle 44 may be in fluid communication with one or more fluid circuits (not shown) that extend within and/or through the end cover 42. In particular configurations, a cap assembly 46 extends radially, circumferentially and axially within the outer casing 40. The cap assembly 46 at least partially surrounds the fuel nozzle 44.

In particular embodiments, an annular duct 48 such as a combustion liner or a transition duct extends downstream from the fuel nozzle 44. The annular duct 48 generally includes an inner or combustion side 50 radially separated from an outer or cool side 52. An upstream or forward end 54 of the annular duct 48 may extend circumferentially around a portion of the cap assembly 46. The annular duct 48 extends at least partially between the cap assembly 46 and an inlet 56 to the turbine 28 (FIG. 1).

As shown in FIG. 2, the annular duct 48 may at least partially define a combustion chamber 58 within the combustor 24 downstream from the fuel nozzle 44. The annular liner 48 at least partially defines a hot gas path 60 within the combustor 24 for routing the combustion gases 26 from the combustion chamber 58 through the combustor 24 and into the turbine 26 (FIG. 1). In particular embodiments, as shown in FIG. 2, at least one outer sleeve 62 such as an impingement or flow sleeve circumferentially surrounds the annular duct 48. The outer sleeve 62 is radially separated from the annular duct 48 so as to define a cooling flow passage 64 therebetween. A plurality of impingement or flow holes 66 may extend through the outer sleeve 62 for routing a portion of the compressed air 18 into the cooling flow passage 64.

The annular duct 48 at least partially defines a plurality of fuel injector orifices 68 that are arranged circumferentially around the annular duct 48 downstream from the fuel nozzle 44. A plurality of fuel injectors 70, also known as late lean injectors (LLIs), are arranged circumferentially around the annular duct 48 and extend at least partially through the fuel injector openings 68. The fuel injectors 70 may be connected to the annular duct 48 by any means suitable for the operating environment within the combustor 24 such as by welding, brazing or mechanical fasteners such as bolts or rivets.

As shown in FIG. 2, the fuel injectors 70 may be at least partially surrounded by the outer sleeve 62. For example, the fuel injectors 70 may be disposed at least partially within the cooling flow passage 64. The fuel injectors 70 provide for fluid communication through the annular duct 48 into the hot gas path 60 at a position that is downstream from the fuel nozzle 44. For example, the fuel injectors 70 may provide for fluid communication between the cooling flow passage 64 and the hot gas path 60. In particular embodiments, the annular duct 48 at least partially defines an orifice 72 that defines a flow path 74 through the annular duct 48 into the hot gas path 60. In one embodiment, as shown in FIG. 2, the orifice 72 is defined downstream from the fuel nozzle 44 and upstream from the fuel injector openings 68 and/or upstream from the fuel injectors 70.

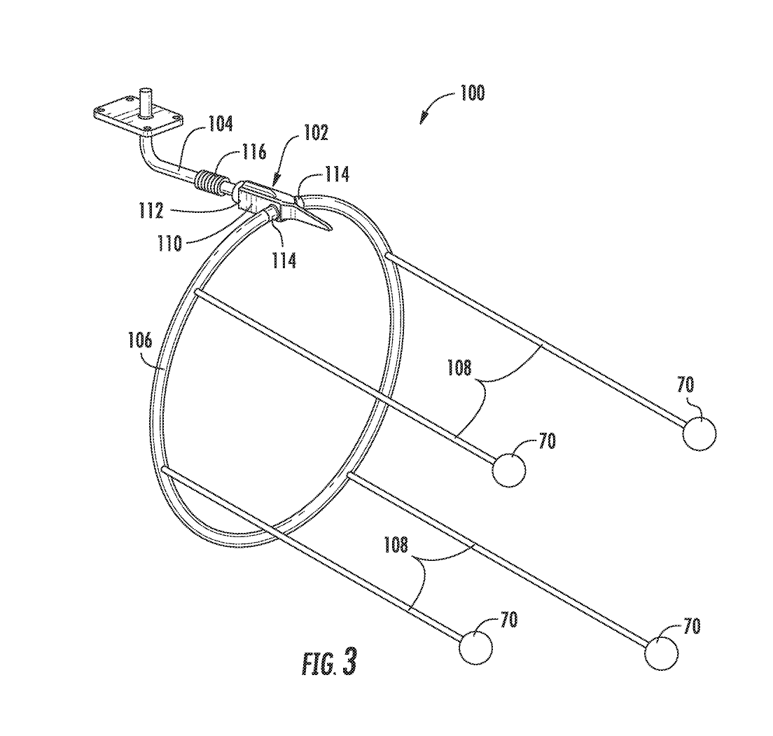

In various embodiments, a system for providing fuel from a fuel source to the fuel injectors 70, herein referred to as “system 100”, extends primarily within the outer casing 40. FIG. 3 provides a perspective view of the system 100 as shown in FIG. 2, according to one embodiment. In one embodiment, as shown in FIGS. 2 and 3, the system 100 generally includes a fuel distribution manifold 102 and a fuel supply conduit 104 that provides for fluid communication between the fuel source 22 (FIG. 1) and the fuel distribution manifold 102.

In one embodiment, as shown in FIGS. 2 and 3, the system 100 includes a ring shaped fluid conduit 106 that is in fluid communication with the fuel distribution manifold 102 upstream from the fuel injectors 70 and downstream from the fuel source and a plurality of fluid conduits 108 that provide for fluid communication between the ring shaped fluid conduit 106 and the fuel injectors 70. As shown in FIG. 2, the fuel distribution manifold 102 is coupled to the annular duct 48 generally adjacent to the outer side 52 upstream from the fuel injectors 70. In one embodiment, as shown in FIG. 2, the fuel distribution manifold 102 is connected to the annular duct 48 generally adjacent to the upstream end 54. In particular embodiments, a portion of the fuel distribution manifold 102 extends across the orifice 72.

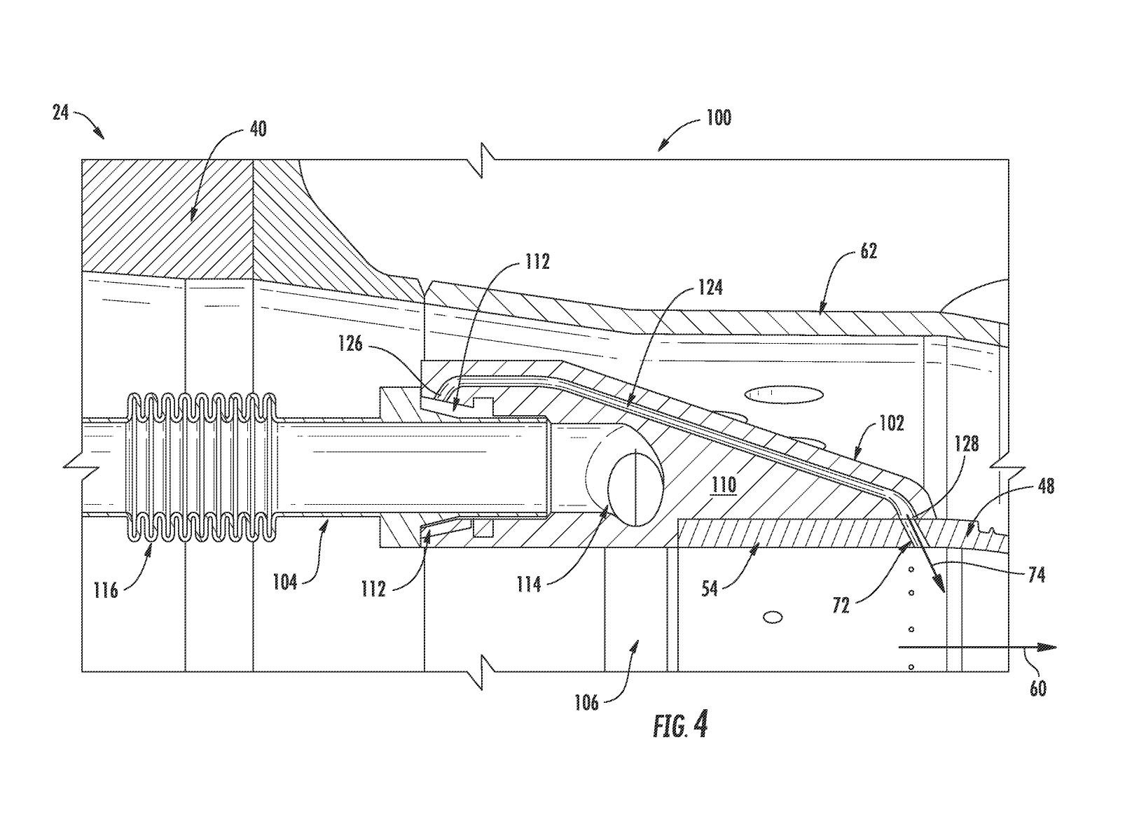

FIG. 4 provides a cross section side view of a portion of the combustor 24 including a portion of the system 100, the annular duct 48, the outer casing 40 and a the outer sleeve 62. As shown in FIGS. 3 and 4, the fuel distribution manifold 102 comprises a main body 110. The main body 110 at least partially defines an inlet 112 and at least one outlet 114 that is in fluid communication with the inlet 112. In at least one embodiment, the ring shaped fluid conduit 106 is in fluid communication with the outlet 114. The inlet 112 is configured to mate with the fuel supply conduit 104 so as to receive fuel from the fuel source 22 (FIG. 1). In one embodiment, as shown in FIGS. 3 and 4, the fuel supply conduit 104 includes a bendable portion 116 for accommodating potential tolerance issues during assembly and/or to allow for relative movement between the annular duct 48 and the outer casing 40 and/or the end cover 42 during operation of the combustor 24. For example, the bendable portion 116 may comprise a bellows.

Referring back to FIG. 2, the outer casing 40 may at least partially define an opening or slot 118 that provides for access through the outer casing 40 into the combustor 24. In one embodiment, the fuel supply conduit 104 extends through the opening 118. The fuel supply conduit 104 may be held in place using a plate 120 or other securing/sealing device so as to seal the opening 118. In alternate embodiments, the fuel supply conduit 104 may be fluidly coupled to the end cover 42. For example, the fuel supply conduit 104 may be coupled to a fluid fitting 122 that is secured to the end cover 42. The fluid fitting 122 may be in fluid communication with the fuel source.

Referring back to FIG. 4, in particular embodiments, the main body 110 defines a fuel purge passage 124. The fuel purge passage 124 includes an inlet orifice 126 that is in fluid communication with the inlet 112 and an outlet orifice 128 that is in fluid communication with the orifice 72. The fuel purge passage 124 provides for fluid communication between the inlet 112 and the orifice 72 and/or the hot gas path 60.

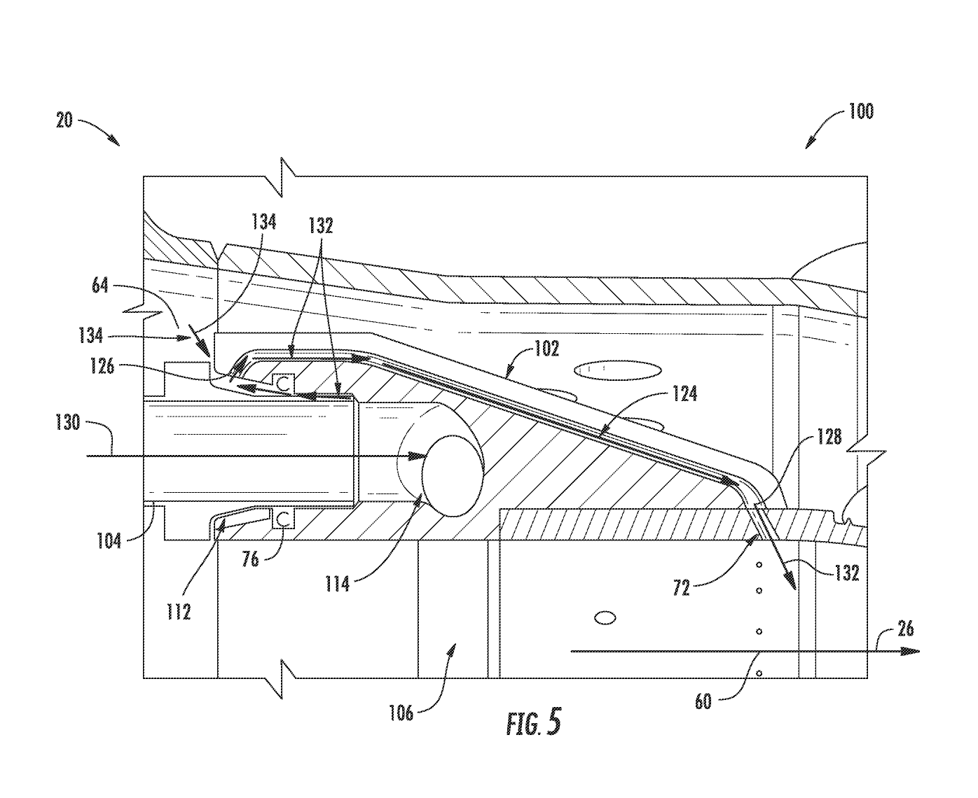

FIG. 5 provides a cross section side view of a portion of the system 100 as shown in FIG. 4, according to one embodiment. In operation, as shown in FIG. 5, fuel 130 is provided from the fuel source 22 (FIG. 1) through the fluid conduit 106 and into the inlet 112 of the fuel distribution manifold 102. The fuel 130 flows through the outlet 114 and into the ring shaped fluid conduit 106 (FIGS. 2 and 3). The fuel 130 is then distributed through the fluid conduits 108 (FIGS. 2 and 3) into the fuel injectors 70 (FIGS. 2 and 3) where it is mixed with a portion of the compressed working fluid 18 before it is injected into the hot gas path 60 (FIG. 2) downstream from the fuel nozzle 44 (FIG. 2).

In one embodiment, as shown in FIG. 5, a portion of the fuel 130 may leak between the fluid conduit 104 and the inlet 112 pass a metal seal 76 such as a “C” seal that is disposed in the main body 110 of the fuel distribution manifold 102. The leaked fuel 132 is drawn into the inlet orifice 126 due in part to a pressure drop between the inlet 112, the cooling flow passage 64 and the hot gas path 60. Purge air 136 combines with the leaked fuel 132 and flows through the fuel purge passage 124 out of the outlet orifice 128 through the orifice 72 and into the hot gas path 60 downstream from the fuel nozzle 44 (FIG. 2) and upstream from the fuel injectors 70 (FIG. 2). As shown in FIG. 5, any leaked fuel 132 bypasses the outlet 114 and the fuel injectors 70. The unburned leaked fuel 132 combusts within the hot gas path 60 as it mixes with the combustion gases 26 flowing therethrough. As a result, the leaked fuel 132 is prevented from stagnating within the inlet 112 and/or the combustor 24, thus reducing the potential for combustion outside of the hot gas path 60 (FIG. 2) and/or the combustion chamber 54 (FIG. 2).

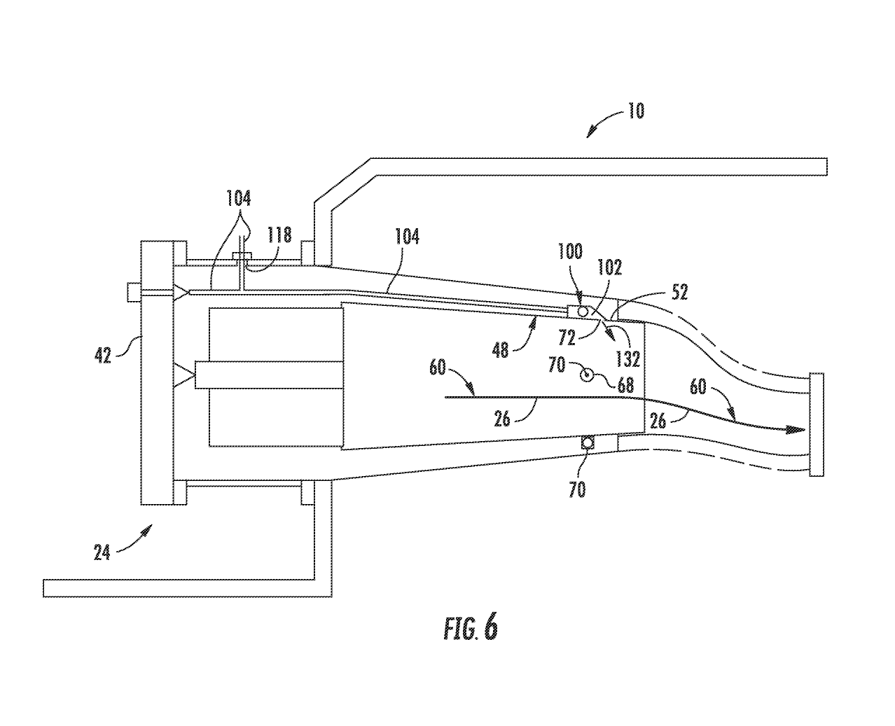

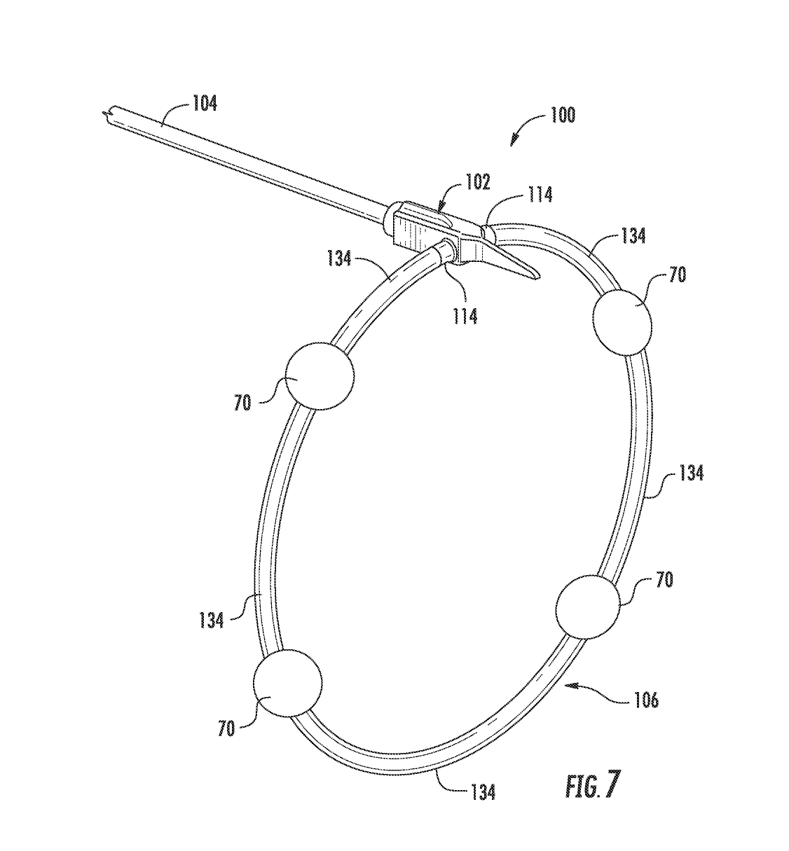

FIG. 6 provides a cross section side view of a portion of the gas turbine 10 including the combustor 24 and the system 100 according to another embodiment of the present invention. FIG. 7 provides a perspective view of the system 100 as shown in FIG. 6. As shown in FIG. 6, the fuel distribution manifold 102 may be disposed along the outer side 52 of the annular duct 48 generally adjacent to the fuel injectors 70. The fuel supply conduit 104 may extend along the outer surface 52 towards the end cover 42. The fuel supply conduit 104 may extend through the slot 118 or may be coupled to the end cover 42 and/or the end cover fitting 122 so as to provide for fluid communication between the fuel source and the inlet 112 of the fuel distribution manifold 102.

As shown in FIG. 7, a plurality of fluid conduits 134 extends circumferentially between the fuel injectors 70 to provide for fluid communication therebetween. As shown in FIG. 6, the plurality of fluid conduits 134 and the fuel injectors 70 are arranged circumferentially around the annular duct 48. In the alternative, as shown in FIG. 7, the fuel injectors 70 may be arranged circumferentially around the ring shaped fluid conduit 106 and fluidly connected to the ring shaped fluid conduit 106. At least one of the fluid conduits 134 is in fluid communication with the outlet 114 of the fuel distribution manifold 102. As shown in FIG. 6, the orifice 72 extends through the annular duct 48 at or downstream from the fuel injector 70, thereby providing for fluid communication into the hot gas path 60 at or downstream from the fuel injectors 70.

In operation, as shown in FIG. 5, the leaked fuel 132 from the inlet 112 is routed through the inlet orifice 126, through the fuel purge passage 124, out of the outlet orifice 128 into the orifice 72 and into the hot gas path 60. As shown in FIG. 6, the leaked fuel 132 is routed into the hot gas path 60 at or downstream from the fuel injectors 70 and/or the fuel injector openings 68. The leaked fuel 132 combusts as it mixes with the combustion gases 26 and with the fuel 130 and compressed working fluid 18 provided to the hot gas path 60 from the fuel injectors 70.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A fuel supply system for a gas turbine combustor, comprising:
a. an annular duct that at least partially defines a hot gas path within the combustor, the annular duct having an inner side and an outer side;
b. an orifice at least partially defined by the annular duct, wherein the orifice defines a flow path through the annular duct into the hot gas path;
c. a plurality of fuel injectors arranged circumferentially around the annular duct, wherein the fuel injectors provide for fluid communication through the annular duct into the hot gas path; and
d. a fuel distribution manifold adjacent to the outer side of the annular duct, the fuel distribution manifold having a main body that at least partially defines an inlet for receiving fuel, an outlet in fluid communication with the fuel injectors, and a fuel purge passage that provides for fluid communication between the inlet and the orifice.

2. The fuel supply system as in claim 1, wherein the orifice provides for fluid communication into the hot gas path upstream from the fuel injectors.

3. The fuel supply system as in claim 1, wherein the orifice provides for fluid communication into the hot gas path downstream from the fuel injectors.

4. The fuel supply system as in claim 1, further comprising a fuel supply conduit that provides for fluid communication between a fuel source and the inlet of the fuel distribution manifold.

5. The fuel supply system as in claim 1, further comprising a plurality of fluid conduits that extend circumferentially between the fuel injectors to provide for fluid communication therebetween, wherein at least one of the fluid conduits is in fluid communication with the outlet of the fuel distribution manifold.

6. The fuel supply system as in claim 1, further comprising a ring shaped fluid conduit that is in fluid communication with the outlet of the fuel distribution manifold upstream from the fuel injectors.

7. The fuel supply system as in claim 6, further comprising a plurality of fluid conduits that provide for fluid communication between the ring shaped fluid conduit and the fuel injectors.

8. A combustor, comprising:
a. an outer casing and an end cover that at least partially encase the combustor;
b. a fuel nozzle that extends axially downstream from the end cover;
c. an annular duct that extends downstream from the fuel nozzle and at least partially defines a hot gas path within the combustor;
d. an orifice that defines a flow path through the annular duct into the hot gas path downstream from the fuel nozzle;
e. a plurality of fuel injectors arranged circumferentially around the annular duct, wherein the fuel injectors provide for fluid communication through the annular duct into the hot gas path downstream from the fuel nozzle;
f. a fuel distribution manifold coupled to the annular duct upstream from the fuel injectors, the fuel distribution manifold having a main body that at least partially defines an inlet for receiving fuel, an outlet in fluid communication with the fuel injectors, and a fuel purge passage that is in fluid communication with the orifice; and
g. wherein the fuel purge passage defines a flow path within the main body for routing leaked fuel from the inlet into the hot gas path.

9. The combustor as in claim 8, wherein the orifice provides for fluid communication into the hot gas path upstream from the fuel injectors.

10. The combustor as in claim 8, wherein the orifice provides for fluid communication into the hot gas path downstream from the fuel injectors.

11. The combustor as in claim 8, further comprising a plurality of fluid conduits that extend circumferentially around the annular duct between the fuel injectors to provide for fluid communication therebetween, wherein at least one of the fluid conduits is in fluid communication with the outlet of the fuel distribution manifold.

12. The combustor as in claim 8, further comprising a ring shaped fluid conduit that is in fluid communication with the outlet of the fuel distribution manifold upstream from the fuel injectors, and a plurality of fluid conduits that provide for fluid communication between the ring shaped fluid conduit and the fuel injectors.

13. The combustor as in claim 8, further comprising a fuel supply conduit that provides for fluid communication between a fuel source and the inlet of the fuel distribution manifold, wherein the fuel supply conduit is fluidly coupled to the end cover.

14. The combustor as in claim 8, further comprising a fuel supply conduit that provides for fluid communication between a fuel source and the inlet of the fuel distribution manifold and a slot defined in the outer casing that provides for access through the outer casing into the combustor, wherein the fuel supply conduit extends through the slot.

15. The combustor as in claim 14, wherein the fuel supply conduit comprises a bendable portion that is upstream from the inlet.

16. A gas turbine, comprising:
a. a compressor;
b. a combustor disposed downstream from the compressor;
c. a turbine disposed downstream from the combustor; and
d. wherein the combustor comprises:
i. an outer casing and an end cover that at least partially encase the combustor;
ii. a fuel nozzle that extends axially downstream from the end cover;
iii. an annular duct that extends downstream from the fuel nozzle and at least partially defines a hot gas path within the combustor;
iv. an orifice that defines a flow path through the annular duct into the hot gas path downstream from the fuel nozzle;
v. a plurality of fuel injectors arranged circumferentially around the annular duct, wherein the fuel injectors provide for fluid communication through the annular duct into the hot gas path downstream from the fuel nozzle;
vi. a fuel distribution manifold coupled to the annular duct upstream from the fuel injectors, the fuel distribution manifold having a main body that at least partially defines an inlet for receiving fuel, an outlet in fluid communication with the fuel injectors, and a fuel purge passage that is in fluid communication with the orifice; and
vii. wherein the fuel purge passage defines a flow path within the main body for routing leaked fuel from the inlet into the hot gas path via the orifice.

17. The gas turbine as in claim 16, wherein the orifice provides for fluid communication into the hot gas path upstream from the fuel injectors.

18. The gas turbine as in claim 16, further comprising a ring shaped fluid conduit that is in fluid communication with the outlet of the fuel distribution manifold upstream from the fuel injectors, and a plurality of fluid conduits that provide for fluid communication between the ring shaped fluid conduit and the fuel injectors.

19. The gas turbine as in claim 16, further comprising a fluid conduit that provides for fluid communication between a fuel source and the inlet of the fuel distribution manifold, wherein the fluid conduit is fluidly coupled to the end cover.

20. The gas turbine as in claim 16, further comprising a fluid conduit that provides for fluid communication between a fuel source and the inlet of the fuel distribution manifold and a slot that provides for access through the outer casing, wherein the fluid conduit extends through the slot.
